(19) United States
(12) Patent Application Publication
(10) Pub. No.: US 2022/0145892 A1
(43) Pub. Date: May 12, 2022

(54) DETERMINATION OF VOLUME FLOW RATE

(71) Applicant: ebm-papst Mulfingen GmbH & Co. KG, Mulfingen (DE)

(72) Inventors: Ralph WYSTUP, Künzelsau (DE); Michael ECCARIUS, Rietheim- Weilheim (DE); Hendrik MOHR, Wolpertshausen (DE)

(73) Assignee: ebm-papst Mulfingen GmbH & Co. KG, Mulfingen (DE)

(21) Appl. No.: 17/418,181

(22) PCT Filed: Sep. 6, 2019
(86) PCT No.: PCT/EP2019/073870

§ 371 Date: Jun. 24, 2021

(30) Foreign Application Priority Data
Jan. 16, 2019 (DE) 102019101022.5

(51) Int. Cl. F04D 17/16; F04D 27/00; F04D 19/00

(52) U.S. Cl. CPC F04D 17/16; F04D 27/001; F04D 19/002; F04D 27/004

(57) ABSTRACT

A fan volume flow rate detection device has a motor (M) with a speed controller (D) and at least one microcontroller (10). The speed (n) of the motor (M) is input at an input of the microcontroller as an input variable, in the form of a digital signal. This is used to determine the pressure difference Δp generated by the impeller wheel at this speed and the volume flow rate ΔV/Δt at a location (x) in a flow channel of the fan in a specific installation situation of a system (A), by a simulation model (SM) stored in memory of the microcontroller (10). Accordingly, the speed (n) of the motor is adjusted by the speed controller in the event of a deviation from a setpoint volume flow rate ΔVₛₑₜₚₒᵢₙₜ/Δt.

### CROSS-REFERENCE TO RELATED APPLICATIONS

This application is a 371 U.S. National Phase of International Application No. PCT/EP2019/073870, filed Sep. 6, 2019, which claims priority to German Patent Application No. 10 2019 101 022.5, filed Jan. 16, 2019. The entire disclosures of the above applications are incorporated herein by reference.

### FIELD

The disclosure relates to a volume flow rate detection device that determines the volume flow rate of a fan without requiring a volume flow rate sensor.

### SUMMARY

For volume flow rate control of fans, it is necessary to know the volume flow rate that the fan generates. The volume flow rate control of fans is important, for example, when a constant volume flow rate of air is to be supplied to an air conditioned space. Moreover, volume flow rate controls are used to control a constant volume flow rate or a constant overpressure of a space in clean rooms, for example, in semiconductor production.

From the prior art, it is known to carry out the control of the volume flow rate that is output by a blower on the basis of the measured volume flow rate. In the context of very expensive system solutions, here it is possible to vary the speed of the blower motor by means of frequency converters or to influence the output of the blower or fan and thus to influence the volume flow rate by means of a variation of the blade position, if the setpoint volume flow rate deviates from the actual volume flow rate.

The known possibilities for the volume flow rate control typically use a sensor arranged in the flow channel, in connection with a volume flow rate measuring device.

One disadvantage is the additional costs for the measuring device and the sensor. Another disadvantage is the installation cost and also the negative effects on the air flow rate, such as, for example, the increase of the flow resistance and occurring turbulence.

The underlying aim of the disclosure is to avoid the aforementioned disadvantages and to provide a simpler and more cost effective solution to determine the volume flow rate, in particular, under the premise of dispensing with interfering measuring devices.

The aim is achieved by the combination of features of a volume flow rate detection device for a fan comprising a motor having a speed controller and at least one microcontroller. The speed (n) of the motor is input at an input of the microcontroller as an input variable in the form of a digital signal, in order to determine a pressure difference ΔV/Δt at a location x in a flow channel of the fan in a specific installation situation of a system, by means of a simulation model stored in a memory of the microcontroller and in order to adjust the speed (n) of the motor accordingly, by the speed controller, in the event of a deviation from a setpoint volume flow rate ΔV_{Setpoint}/Δt.

The underlying idea of the present disclosure uses a simulation model in order to determine the volume flow rate by means of a microcontroller, from the speed (n) of the motor of the ventilator or fan. The motor speed (n) is used as an input variable for calculations. The determination of the volume flow rate and of the pressure difference is generated from the model. A correction factor determined from the measurements, is preferably used for the harmonization of the measurement results and simulation in order to determine the volume flow rate with a specified accuracy.

Here, the simulation comprises: an ideal pressure generation, the calculation of the occurring losses, the calculation of the volume flow rate as a function of pressure and the system resistance (which is assumed to be known), and the correction of the results.

Thus, according to the disclosure a volume flow rate detection device of a fan comprises a motor with a speed controller and at least one microcontroller. The speed (n) of the motor is input at an input of the microcontroller as an input variable in the form of a digital signal in order to determine the pressure difference Δp generated by the impeller wheel at this speed and the volume flow rate ΔV/Δt at a location x in a flow channel of the fan in a specific installation situation of a system, by means of the simulation model “SM” stored in a memory of the microcontroller. Thus this enables adjustment of the speed (n) of the motor accordingly by means of the speed controller (preferably iteratively), in particular, in the event of a deviation from a setpoint volume flow rate ΔVₛₑₜₚₒᵢₙₜ/Δt.

In a preferred design of the disclosure the simulation model “SM” for the determination of the pressure difference Δp and the volume flow rate ΔV/Δt comprises an impeller wheel model “LM” for the impeller wheel. Here, at least the angular frequency ω of the motor is used as an input variable. The impeller wheel model simulates the impeller wheel of the fan in a microcontroller-controlled circuit arrangement. However, in a comparison of the simulation results with the measurements on a fan, increasing deviation arises with increasing volume flow rate, since the occurring losses then accordingly have a greater influence.

Thus, it is moreover advantageous if, in addition to the pressure difference Δp determined from the simulation model, a correction factor K for flow losses ΔV_{Loss}/Δt is also used in the volume flow rate determination of the volume flow rate ΔV/Δt. Thus, a deviation of the actual flow conditions is corrected with respect to the ideal fan characteristic curve and with respect to the flow conditions without the presence of flow losses of the fan.

In an additional advantageous design of the disclosure the correction factor K as a pressure loss coefficient ζₐ takes into account the losses, at least from the friction losses, the impact losses and the gap losses in the flow channel that lead to a volume flow rate deviation at the location (x) of the system.

From the pressure difference calculated in the impeller wheel model, that is to say, from the “ideal” pressure minus the pressure losses, in the model of the system with specification of a pressure loss coefficient ζₐ, the resulting volume flow rate is calculated. The system represents the fluid mechanical resistance, the ratio between volume flow rate and pressure difference and the inertia of the moved air, in order to achieve the most accurate result possible.

Consequently, it is moreover advantageous if the correction factor K, as a function of the pressure loss coefficient ζₐ (ΔV/Δt, n), has been determined as a function of the volume flow rate ΔV/Δt and of the speed (n) on the basis of a reference measurement carried out with the fan or with a fan of identical design from the quotient of the measured pressure difference with respect to the calculated pressure difference as follows:

K=K(ζₐ)=(Δp_{Setpoint}/Δp_{Measurement}).

According to the disclosure at least for the speed range with speeds (n) between 500/min and 1900/min, a correction factor K is determined.

In a preferred embodiment, the impeller wheel model is accordingly designed so that the total volume flow rate and ΔV_{Total}/Δt including the losses ΔV_{Loss}/Δt is determined as follows:

ΔV_{Total}/Δt=ΔV_{Loss}/Δt+ΔV/Δt.

An additional aspect of the present disclosure relates to a ventilation system with a volume flow rate detection device as described above.

Yet another aspect of the present disclosure relates to a method for the detection of the volume flow rate of a fan comprising a motor having a speed controller and at least one microcontroller, with the following steps:

a. inputing the speed (n) of the motor at an input of the microcontroller as an input variable in the form of a digital signal;

b. storing a simulation model “SM” in memory of the microcontroller, and determining the pressure difference Δp generated by the impeller wheel at this speed and the volume flow rate ΔV/Δt at a location (x) in a flow channel of the fan in a specific installation situation of a system; and

c. adjusting, in the event of a deviation of the determined actual volume flow rate ΔV/Δt from a setpoint volume flow rate ΔVₛₑₜₚₒᵢₙₜ/Δt, the speed (n) of the motor of the speed controller.

In an advantageous development of the method, the adjusted speed (n) is used again as an input variable in the performance of steps a) to c), until the deviation of the volume flow rate ΔV/Δt is less than a specified acceptable deviation value. Also after a certain number of iterative correction steps, the procedure is interrupted and the value, determined for the determined volume flow rate, is considered to be sufficiently accurate.

It is moreover advantageous if, in the determination of the volume flow rate ΔV/Δt, a correction value K, which corresponds to a pressure loss coefficient ζₐ as a function of the volume flow rate ΔV/Δt, and the speed (n) is taken into account and has been determined on the basis of a reference measurement carried out with the fan or with a fan of identical design from the quotient of the measured pressure difference with respect to the calculated pressure difference as follows:

K=K(ζₐ)=(Δp_{Setpoint}/Δp_{Measurement}).

### DRAWINGS

Further areas of applicability will become apparent from the description provided herein. The description and specific examples in this summary are intended for purposes of illustration only and are not intended to limit the scope of the present disclosure.

Other advantageous developments of the disclosure are characterized in the dependent claims and represented in greater detail below together with the description of the preferred embodiment of the invention in reference to the figures.

In the figures:

FIG. 1 is a block diagram of a simulation model in a quadrupole representation;

FIG. 2 is a block diagram of a signal flow diagram of an impeller wheel model;

FIG. 3 is a block diagram of an impeller wheel model in a quadrupole representation;

FIG. 4 is a block diagram of a signal flow diagram for a system;

FIG. 5 is a graph illustrating the deviation between the measurement of the volume flow rate and the simulation;

FIG. 6 is a graph of the course of the array of curves of correction functions; and

FIG. 7 is a graph of a representation of the results of the application of the correction function to the determined simulation values.

### DETAILED DESCRIPTION

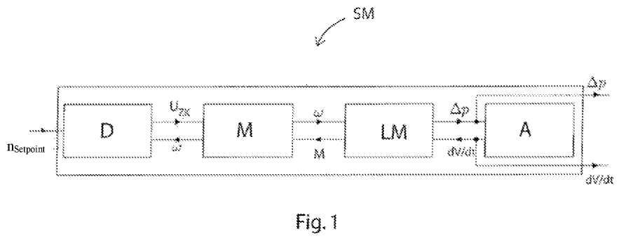

Below, the disclosure is described in greater detail using an embodiment example in reference to FIGS. 1 to 7, wherein identical reference numerals designate identical functional and/or structural features.

In FIG. 1, a simulation model SM in a quadrupole representation is shown. Here, the simulation model represents an overall model with the components: speed controller D of a fan, motor M of the fan, an impeller wheel model LM for the impeller wheel, and the system A where the fan is incorporated.

As input variables, at the start, the setpoint speed (n_{SETPOINT}) is input into the speed controller D which regulates the corresponding intermediate circuit voltage U_{ZK} for the motor M. The angular frequency ω (as variable for the speed of the motor) is used as an input variable for the impeller wheel model LM of the impeller wheel. From this, the generated pressure difference Δp and the volume flow rate ΔV/Δt in the system A are determined.

Additionally, it is shown that the determined volume rate ΔV/Δt in the signal path is returned again to the impeller wheel model LM in a signal control loop.

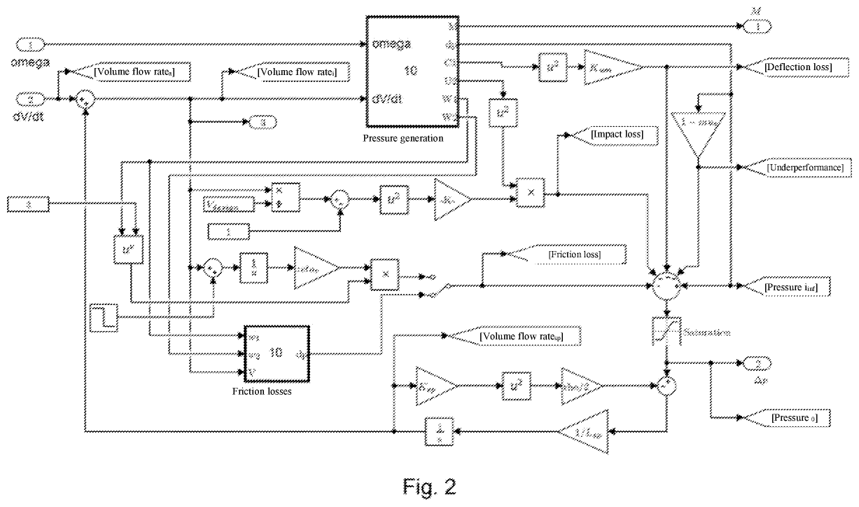

In FIG. 2, a signal flow diagram of an impeller wheel model LM is represented as an example. For this purpose, a microcontroller 10 is provided, at the input of which the speed (n) of the motor M is input as an input variable in the form of a digital signal or of the angular frequency ω, in order to determine, by means of a simulation model SM stored in a memory of the microcontroller 2, the pressure difference Δp generated by the impeller wheel at this speed (at the output 2 in the signal flow diagram) in a flow channel of the fan in a specific installation situation of a system A. At the input 2, as an additional input variable in addition to the angular frequency ω, the volume flow rate ΔV/Δt is determined from the pressure difference Δp determined by the microprocessor 10 and fed back to the microprocessor 10 as an input variable.

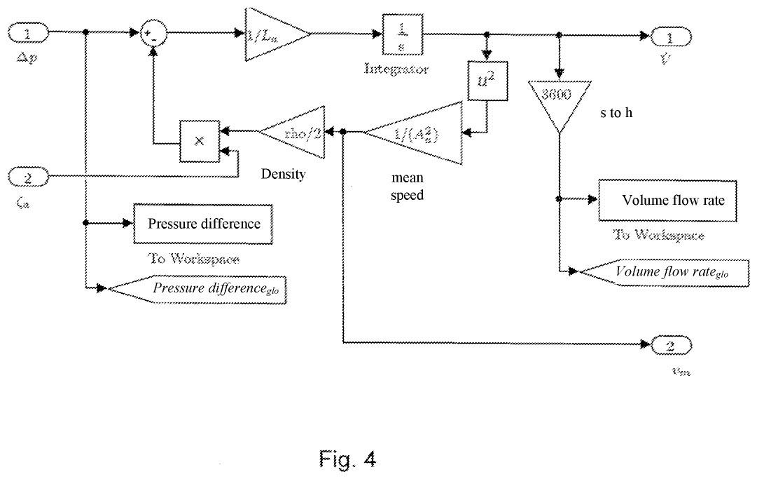

FIG. 4 shows a signal flow diagram for a system A.

The block symbols in FIGS. 2 and 4 here represent known and common components such as, integrator, gain, Boolean and logical operators, input, output, etc., known, for example, as MathWorks Simulink block symbols or MathLab operators, which are represented in the present case for modeling the concrete controlled system of the embodiment examples shown. By means of the simulation model, the concrete controller design can be verified and codes can automatically be generated therefrom, and therefore the description of the individual block symbols in the simulation model is not discussed in greater detail, since its effect results directly from the simulation model representation.

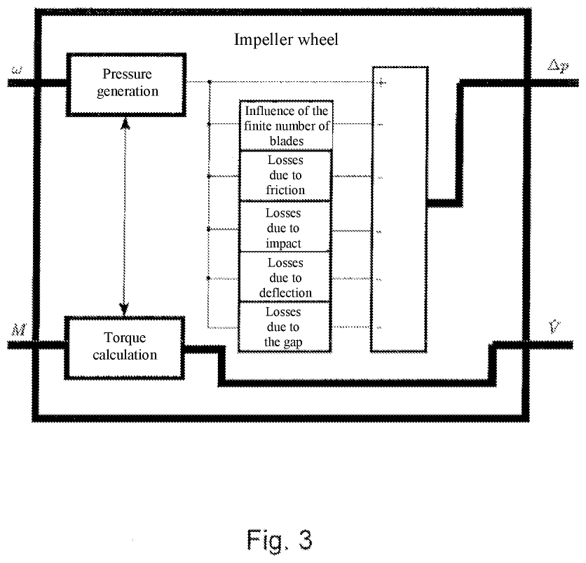

FIG. 3 shows a simplified representation of the impeller wheel model in a quadrupole representation with the variables at the poles: angular frequency ω, pressure difference Δp, volume flow rate ΔV/Δt and torque of the impeller wheel M_{V}. For example, the losses and the influencing variables such as the influence of the finite number of blades, losses due to friction, impact, deflection and due to the gap are represented.

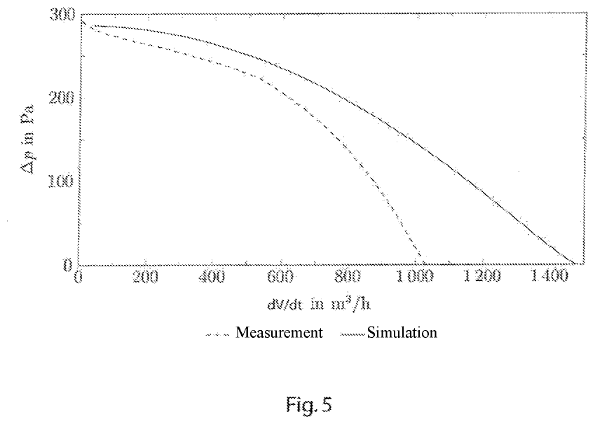

FIG. 5 shows a graph for illustrating the deviation between the measurement (of the two curves, the curve which in the view runs further to the left) of the volume flow rate and the simulation (of the two curves, the curve which in the view runs further to the right), which shows the dependency of the determined pressure difference Δp with respect to the volume flow rate ΔV/Δt.

As basis for the simulation, a fan with the type designation R3G250RV8301 from the company ebm-papst was used. The comparison of the simulation results with the measurements on the fan shows a clear and increasing deviation with increasing volume flow rate.

In order to reduce the deviation between simulation and measurement, a correction function (as described in greater detail above) was used. It determines a respective correction factor for each volume flow rate in the speed range 500/min<n<1900/min.

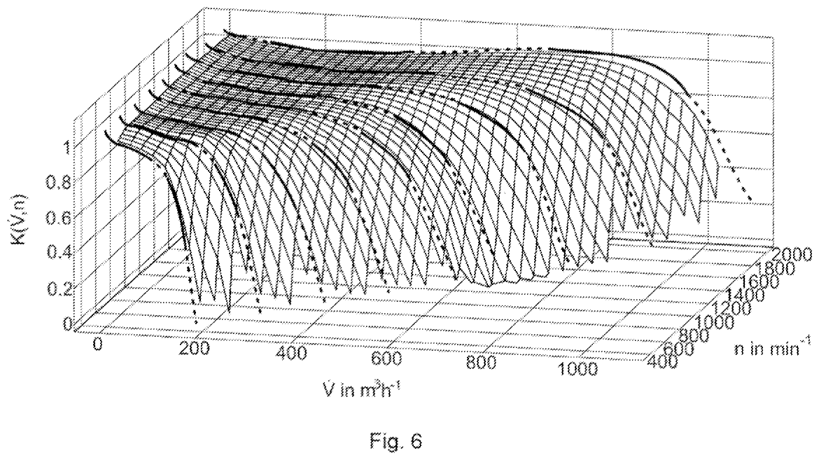

The course of the correction factor or of the array of curves of the correction factor K is represented in greater detail in the diagram of FIG. 6. The third coordinate axis takes into account the speed dependency of the correction factor K on the speed (n).

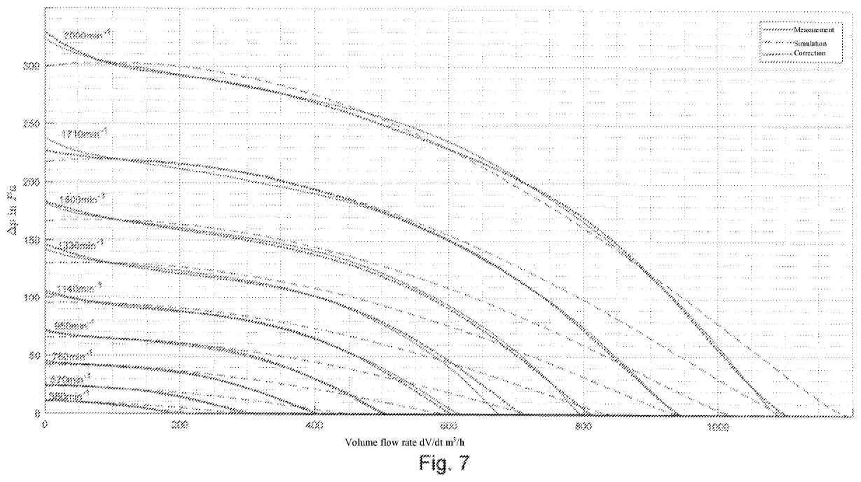

By application of the correction function to the simulation, the deviations of the simulation are greatly reduced. In the diagram of FIG. 7, it can be seen that the result of the correction (black dotted line) now exhibits only very minor deviations with respect to the measurements. The curve leading into the ordinate axis further toward higher volume flow rate ranges in each case represents the simulation curve, while the other curve in each case is the reference measurement curve. Moreover, it should be noted that the simulation results do not reproduce the deflection point of the curve clearly represented in the characteristic curves of the measurement. This flaw in the case of determination of the volume flow rate ΔV/Δt without correction factor is also eliminated by the correction.

The disclosure is not limited in its embodiment to the above-indicated preferred embodiment examples. Instead, a number of variants which use the represented solution are conceivable, including in embodiments of fundamentally different type.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-10. (canceled)

11. A volume flow rate detection device for a fan comprising:
a motor having a speed controller and at least one microcontroller, the speed of the motor is input at an input of the microcontroller as an input variable in the form of a digital signal, in order to determine a pressure difference Δp generated by the impeller wheel at this speed and a volume flow rate ΔV/Δt at a location x in a flow channel of the fan in a specific installation situation of a system, by means of a simulation model (SM) stored in a memory of the microcontroller (10), and in order to adjust the speed n of the motor (M) accordingly by means of the speed controller (D) in the event of a deviation from a setpoint volume flow rate ΔVₛₑₜₚₒᵢₙₜ/Δt.

12. The volume flow rate detection device according to claim 11, wherein the simulation model for the determination of the pressure difference Δp and of the volume flow rate ΔV/Δt comprises an impeller model, wherein at least the angular frequency ω of the motor is used as the input variable.

13. The volume flow rate detection device according to claim 11, wherein in addition to the pressure difference Δp determined from the simulation model, a correction factor K for flow losses ΔVᵢ/Δt is moreover used in the volume flow rate determination of the volume flow rate ΔV/Δt, by a deviation of the actual flow conditions with respect to the ideal fan characteristic curve is corrected without taking into account flow losses of the fan.

14. The volume flow rate detection device according to claim 13, wherein the correction factor K as a pressure loss coefficient ζₐ that takes into account the losses from friction losses, impact losses and gap losses in the flow channel at the location x.

15. The volume flow rate detection device according to claim 14, wherein correction factor K, as a function of the pressure loss coefficient ζₐ (ΔV/Δt, n), has been determined as a function of the volume flow rate ΔV/Δt and the speed n on the basis of a reference measurement carried out with the fan or with a fan of identical design from the quotient of the measured pressure difference with respect to the calculated pressure difference as follows:
K=K(ζₐ)=(Δp_{Setpoint}/Δp_{Measurement}).

16. The volume flow rate detection device according to claim 13, wherein the impeller wheel model is designed so that the total volume flow rate including the losses is determined as follows:
ΔV_{Total}/Δt=ΔV_{Loss}/Δt+ΔV/Δt.

17. A ventilation system (A) with a volume flow rate detection device according to claim 11.

18. A method for the detection of the volume flow rate of a fan comprising a motor (M) having a speed controller (D) and at least one microcontroller, with the following steps:
a. the speed n of the motor is input at an input of the microcontroller as input variable in the form of a digital signal
b. by means of a simulation model (SM) stored in a memory of the microcontroller, the pressure difference Δp generated by the impeller wheel at this speed and the volume flow rate ΔV/Δt at a location x in a flow channel of the fan in a specific installation situation of a system (A) are determined, and
c. in the event of a deviation of the determined actual volume flow rate ΔV/Δt from a setpoint volume flow rate ΔVₛₑₜₚₒᵢₙₜ/Δt, the speed n of the motor is accordingly adjusted by means of the speed controller.

19. The method according to claim 18, wherein the adjusted speed n is used again as input variable in the performance of steps a) to c), until the deviation of the volume flow rate ΔV/Δt is less than a specified acceptable deviation value.

20. The method according to claim 18, wherein in the determination of the volume flow rate ΔV/Δt, a correction value K which corresponds to a pressure loss coefficient ζₐ (ΔV/Δt, n) as a function of the volume flow rate ΔV/Δt and the speed n is taken into account and has been determined on the basis of a reference measurement carried out with the fan or with a fan of identical design from the quotient of the measured pressure difference with respect to the calculated pressure difference as follows:
K=K(ζₐ)=(Δp_{Setpoint}/Δp_{Measurement}).
